(19) United States
(12) Patent Application Publication
(10) Pub. No.: US 2006/0207382 A1
(43) Pub. Date: Sep. 21, 2006

(54) Handlebar stem assembly for a bicycle

(75) Inventor: Cheng-Yun I, Dali City (TW)

Correspondence Address: CHARLES E. BAXLEY, ESQ., 90 JOHN STREET, THIRD FLOOR, NEW YORK, NY, 10038, US

(73) Assignee: Lee Chi Enterprise Company Ltd.

(21) Appl. No.: 11/050,219

(22) Filed: Feb. 3, 2005

(51) Int. Cl. B62K 21/12

(52) U.S. Cl. 74/551.1

(57) ABSTRACT

a handlebar stem assembly for a bicycle capable of adjusting the mounting angle of the handlebar of a bicycle, comprises a front stem, an end which is a locking portion locked on a frame of a bicycle, another end of which is a coupling portion, the coupling portion is slanted to form an angle to a horizontal axis of a base of the front stem; a rear stem, an end of which is a locking hole for insertion of a handlebar of a bicycle, another end of which is a coupling portion for coaxially receiving the coupling portion of the front stem, a center of the locking hole is offset at a deflection angle from the longitudinal axis of the coupling portion of the front stem.

### BACKGROUND OF THE INVENTION

1. Field of the Invention

The present invention relates to a handlebar stem of a bicycle, and more particularly to a handlebar stem assembly capable of adjusting the mounting angle of the handlebar of a bicycle.

2. Description of the Prior Arts

Normally, mounting angle of a handlebar of a bicycle is fixed and unchangeable despite the height of the steering post is adjustable. Therefore, how to make a structure capable of adjusting the mounting angle of the handlebar to meet the user's needs has become an important subject for all the manufacturers.

Referring to FIG. 1, a conventional handlebar stem 10 is a unitary structure horizontally locked to the steering post (not shown) of a bicycle, at an end of the handlebar stem 10 is formed a locking hole 11 for receiving the handlebar 12. However, this conventional structure has some disadvantages that could be improved:

First, the handlebar stem 10 cannot be adjusted anymore once it is horizontally fixed to the steering post, consequently, the handlebar 12 is also horizontally fixed, this might make it uneasy for the user to control the bicycle.

Second, the handlebar 12 is only adjustable in height but not in mounting angle relative to the frame, the thing is that the user has to change his/her riding posture to fit the handle bar 12, but not the handlebar 12 is adjustable to fit the user. As a result, long period of riding might cause uncomfortableness or sports injury.

Third, a professional cyclist must use different bicycles according to road conditions, mounting angle of the handlebar is one of the structural factors of a bicycle, therefore, it is inconvenience for a professional cyclist to carry several types of handlebars and handlebar stems.

Referring to FIG. 2, another conventional handlebar stem 13 is also a unitary structure having a predetermined mounting angle a with respect to the frame of a bicycle and also provided with a locking hole 14 for locking the handlebar 15. However, this conventional structure still has some disadvantages that could be improved:

First, the mounting angle a of the handlebar stem 13 is unchangeable after it is fixed, the user still has to adjust his/her riding posture to fit the handlebar 15, and long period of riding might cause uncomfortableness or sports injury.

Second, the single mounting angle a is not enough, so the professional cyclist still has to choose different bicycles according to road conditions.

The present invention has arisen to mitigate and/or obviate the afore-described disadvantages.

### SUMMARY OF THE INVENTION

The primary objective of the present invention is to provide a handlebar stem assembly for a bicycle capable of adjusting the mounting angle of the handlebar of a bicycle, so as to fit different user's needs.

A handlebar stem assembly for a bicycle provided in accordance with the present invention comprises:

a front stem, an end which formed with a locking portion locked on a frame of a bicycle, another end of the front stem formed with a coupling portion, a longitudinal axis of the coupling portion being slanted to form an angle with respect to a horizontal axis of a base of the front stem;

a rear stem, at an end of its base being formed a locking hole for insertion of a handlebar of a bicycle, another end of the base of the rear stem formed with a coupling portion for coaxially receiving the coupling portion of the front stem, a center of the locking hole being offset at a deflection angle from the longitudinal axis of the coupling portion of the front stem.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional handlebar stem of a bicycle;

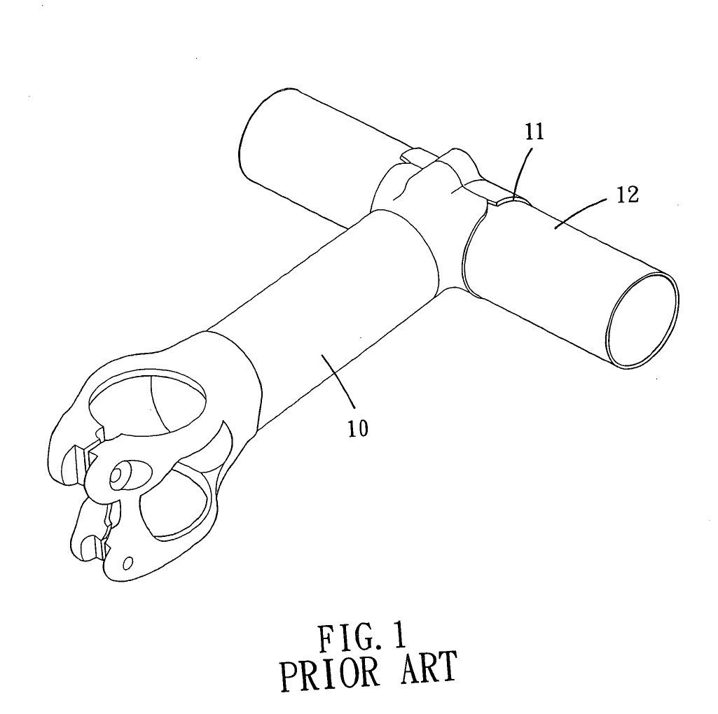

FIG. 2 is a perspective view of another conventional handlebar stem of a bicycle;

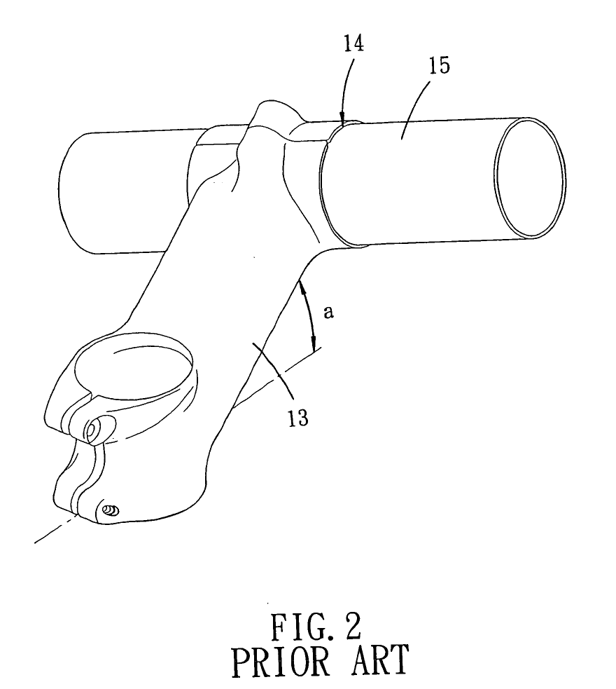

FIG. 3 is an exploded view of a handlebar stem assembly for a bicycle in accordance with a first embodiment of the present invention;

FIG. 4 is a cross sectional view of a handlebar stem assembly for a bicycle in accordance with the first embodiment of the present invention;

FIG. 5 is a cross sectional view of showing the handlebar stem assembly for a bicycle of FIG. 4 after the rear stem is rotated 180 degrees to the front stem;

FIG. 6 is an exploded view of a handlebar stem assembly for a bicycle in accordance with a second embodiment of the present invention;

FIG. 7 is a cross sectional view of a handlebar stem assembly for a bicycle in accordance with the second embodiment of the present invention;

FIG. 8 is a cross sectional view of showing the handlebar stem assembly for a bicycle of FIG. 7 after the rear stem is rotated 180 degrees to the front stem;

FIG. 9 is a cross sectional view of a handlebar stem assembly for a bicycle in accordance with a third embodiment of the present invention;

FIG. 10 is a cross sectional view of showing the handlebar stem assembly for a bicycle of FIG. 9 after the rear stem is rotated 180 degrees to the front stem.

### DETAILED DESCRIPTION OF THE PREFERRED EMBODIMENTS

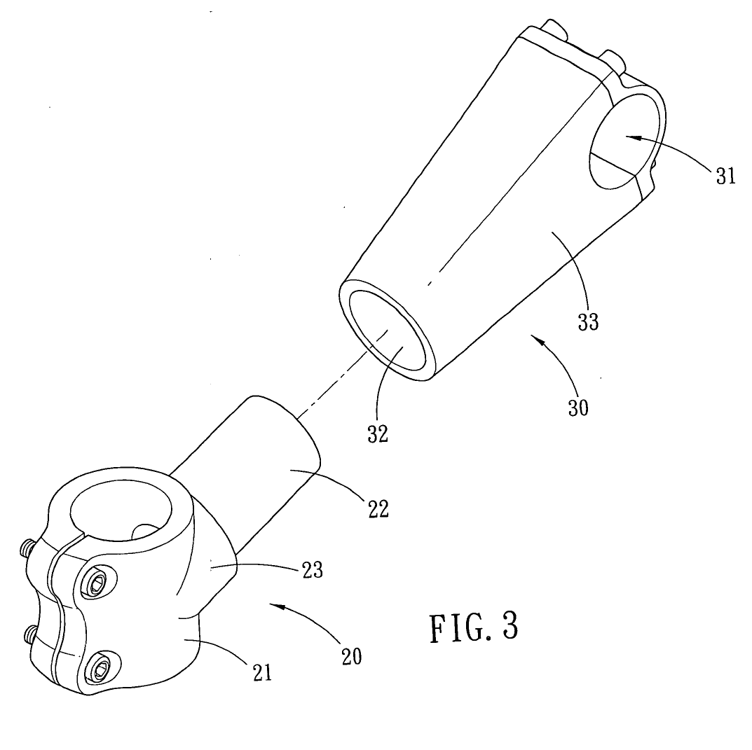

Referring to FIGS. 3-5, a handlebar stem assembly for a bicycle in accordance with the present invention comprises:

A front stem 20, an end of its base 23 is a locking portion 21 locked on the frame of a bicycle, another end of the base 23 is a coupling portion 22. A longitudinal axis of the coupling portion 22 is slanted to form an angle b with respect to the horizontal axis A of the base 23, and the coupling portion 22 is rod-shaped.

A rear stem 30, at an end of its base 33 is formed a locking hole 31 for insertion of the handlebar of a bicycle, another end of the base 33 of the rear stem 30 is a coupling portion 32 which is in the shape of a recess for coaxially receiving the coupling portion 22 of the front stem 20. The center of the locking hole 31 is offset from the longitudinal axis of the coupling portion 22 of the front stem 20 to form a deflection angle X.

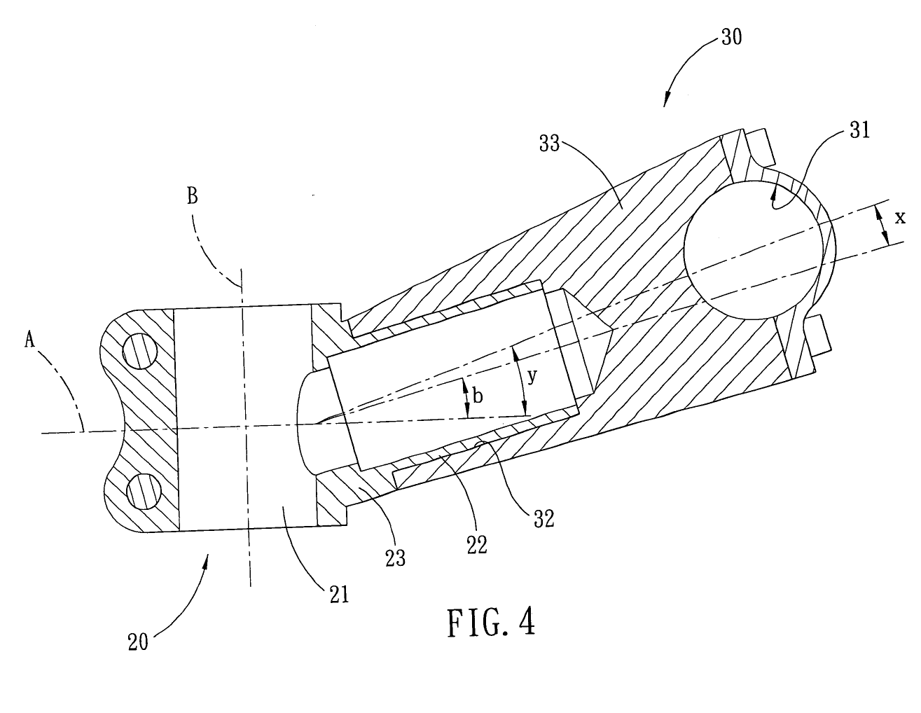

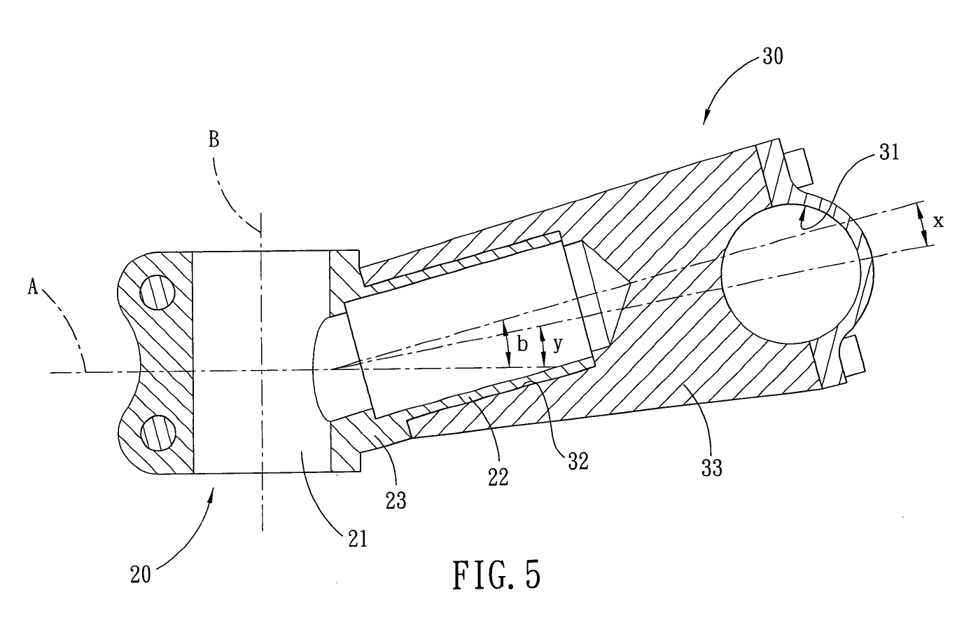

For better understanding the present invention, its operations and functions, references should be made particularly to FIGS. 4 and 5, and initially to FIG. 4, the center of the locking hole 31 is offset upward at an angle X to the longitudinal axis of the coupling portion 22 of front stem 20, and the deflection angle X will be added to the angle b, after the coupling portion 32 is coaxially connected to the coupling portion 22 of the front stem 20.

If the mounting angle of the handlebar stem assembly is Y (the angle between the longitudinal axis of the rear stem 30 and the horizontal axis of A of the base 23 of the front stem 20),

Angle b=13.5 degrees

Angle X=3.5 degrees

then the mounting angle Y=13.5+3.5=17 degrees.

With reference to FIG. 5, if the user loosens the rear stern 30 and rotates it 180 degrees to the front stem 20, and coaxially fixes the rear stem 30 to the front stem 20, the center of the locking hole 31 will be offset downward at an angle X to the longitudinal axis of the coupling portion 22 of front stem 20, and the deflection angle X will be deducted from the angle b.

If the mounting angle of the handlebar stem assembly is Y (the angle between the longitudinal axis of the rear stem 30 and the horizontal axis of A of the base 23 of the front stem 20),

Angle b=13.5 degrees

Angle X=3.5 degrees

then the mounting angle Y=13.5−3.5=10 degrees.

Therefore, the mounting angle Y of the handlebar stem assembly of the present invention can be adjusted easily and quickly to fit different users.

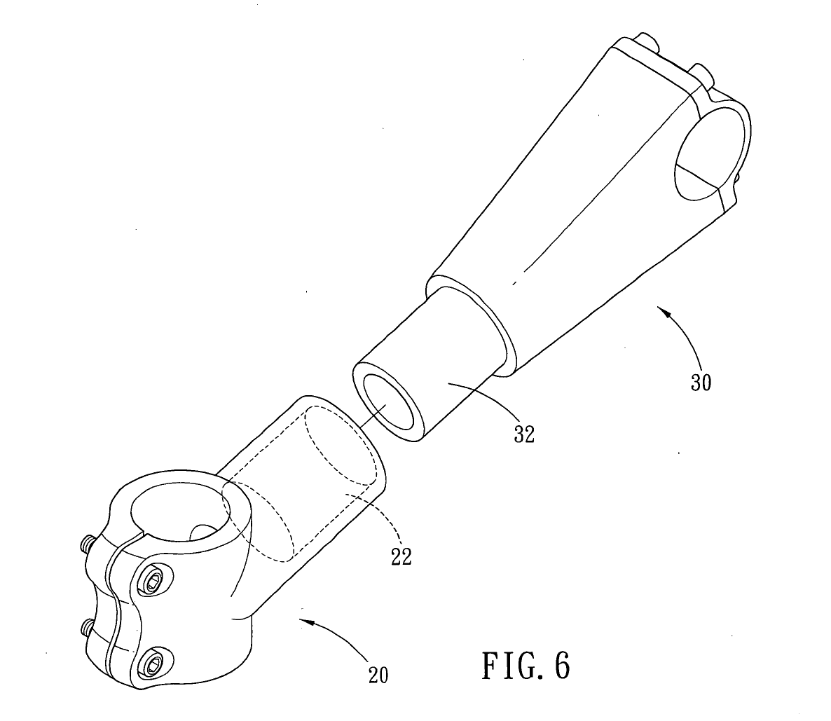

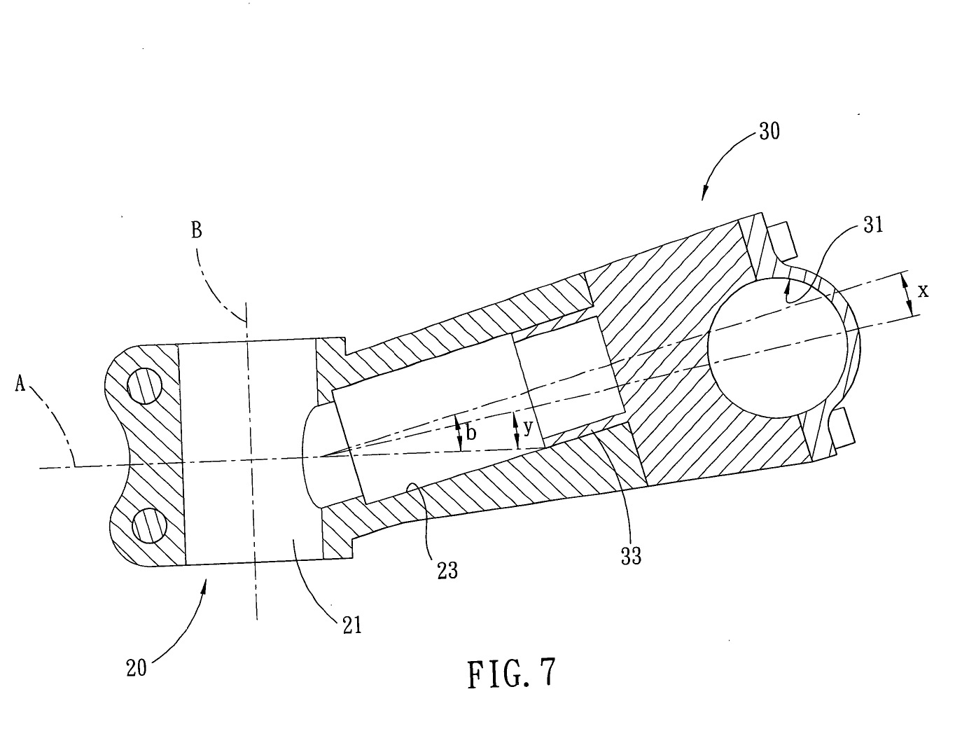

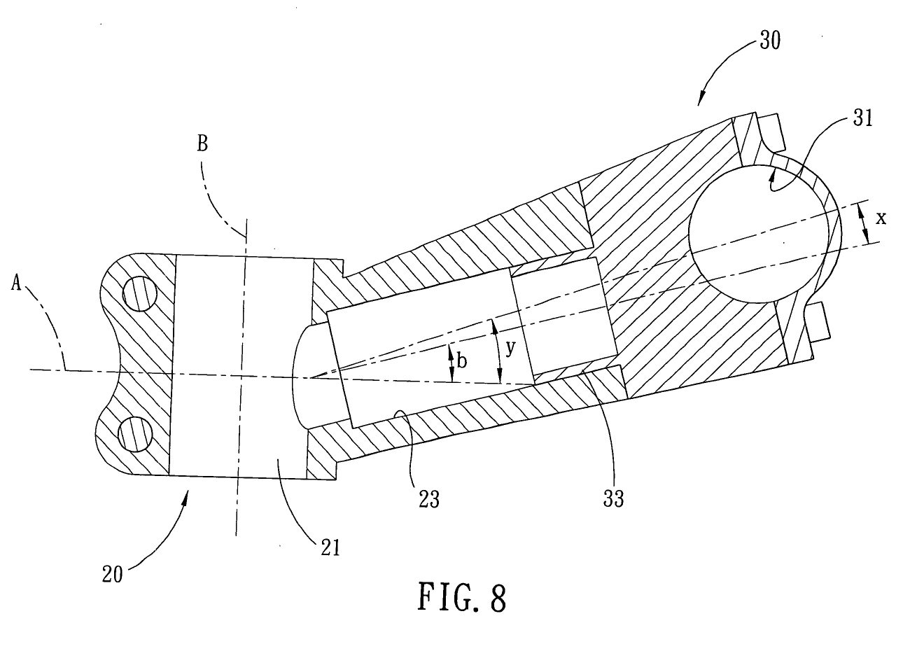

On the other hand, as shown in FIGS. 6-8, which shows a handlebar stem assembly in accordance with a second embodiment of the present invention, wherein the tongue-and-groove coupling mode between the coupling portion 22 of the front stem 20 and the coupling portion 32 of the rear stem 30, in this embodiment is reverse to the first embodiment. The coupling method between the coupling portion 22 of the front stern 20 and the coupling portion 32 of the rear stem 30 includes screws and bolts, quick fastening device, gluing and the like.

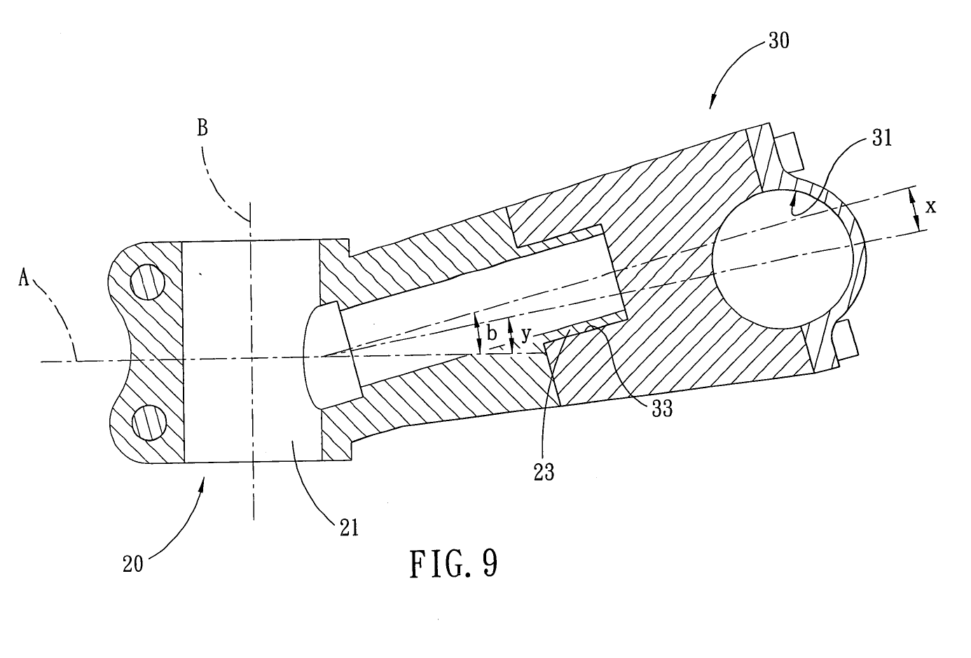

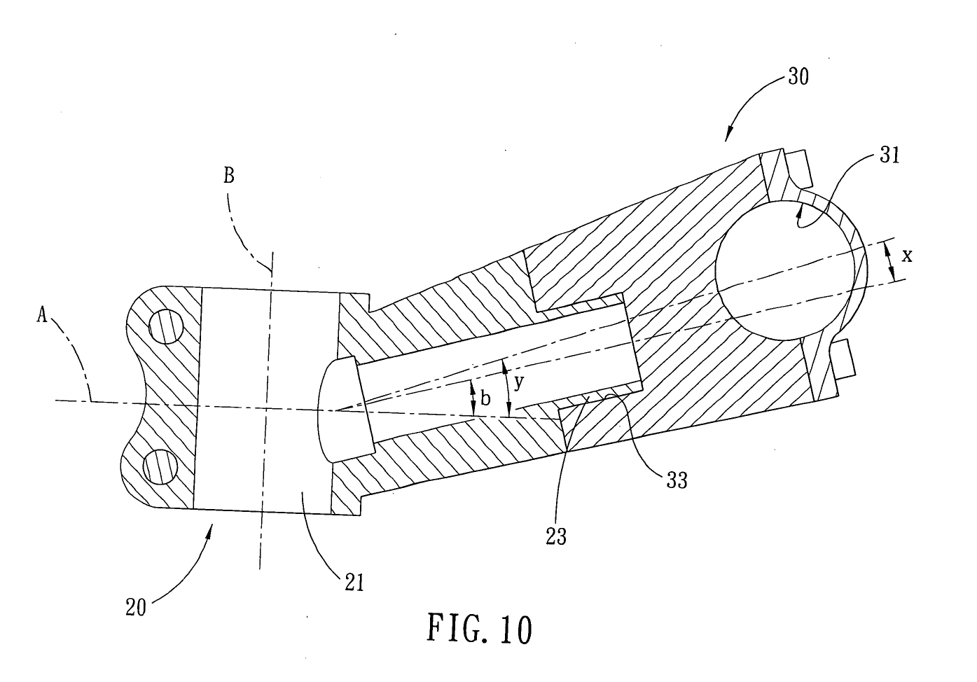

Referring further to FIGS. 9 and 10, which shows a handlebar stem assembly in accordance with a third embodiment of the present invention, wherein the coupling portions 32, 22 of the rear and the front stems 30, 20 can be adjusted in diameter and length according to needs.

While we have shown and described various embodiments in accordance with the present invention, it should be clear to those skilled in the art that further embodiments may be made without departing from the scope of the present invention.

What is claimed is:

1. A handlebar stem assembly for a bicycle comprising:
a front stem, an end which formed with a locking portion locked on a frame of a bicycle, another end of the front stem formed with a coupling portion, a longitudinal axis of the coupling portion being slanted to form an angle with respect to a horizontal axis of a base of the front stem;
a rear stem, at an end of its base being formed a locking hole for insertion of a handlebar of a bicycle, another end of the base of the rear stem formed with a coupling portion for coaxially receiving the coupling portion of the front stem, a center of the locking hole being offset at a deflection angle from the longitudinal axis of the coupling portion of the front stem.

2. The handlebar stem assembly for a bicycle as claimed in claim 1, wherein the coupling portion of the front stem is in the shape of a rod, and the coupling portion of the rear stem is in the shape of a recess for coaxially receiving the coupling portion of the front stem.

3. The handlebar stem assembly for a bicycle as claimed in claim 1, wherein the coupling portion of the rear stem is in the shape of a rod, and the coupling portion of the front stem is in the shape of a recess for coaxially receiving the coupling portion of the rear stem.
